(19) United States
(12) Patent Application Publication
(10) Pub. No.: US 2012/0261384 A1
(43) Pub. Date: Oct. 18, 2012

(54) INTERRUPTER WITH VOLTAGE SENSING ON BOTH LOAD AND SOURCE SIDES

(76) Inventors: Mike LaBianco, Downers Grove, IL (US); William W. Chen, Munster, IN (US); Nenad Uzelac, St. John, IN (US)

(21) Appl. No.: 13/086,723

(22) Filed: Apr. 14, 2011

(51) Int. Cl. H01H 33/66; H01H 31/02

(52) U.S. Cl. 218/118; 200/48 R

(57) ABSTRACT

An interrupter system for a switchgear. The interrupter system includes a source-side conductor, a load side conductor, and an interrupter. A source-side voltage detector is positioned proximate to the source-side conductor and a load-side voltage detector is positioned proximate to the load-side conductor. An insulating overmold encases both conductors, both voltage detectors, and the interrupter. A controller is coupled to both of the detectors and is configured to detect a source-side voltage and a load-side voltage.

### BACKGROUND

The present invention relates to switchgear interrupters and, more specifically, to voltage sensing at an interrupter.

An interrupter for a switchgear system can include a vacuum interrupter for fault interruption. A vacuum interrupter can be viewed or thought of as a ceramic bottle with two mechanical contacts sealed inside a vacuum. Fault interruptions are performed in the vacuum by the interrupter.

### SUMMARY OF THE INVENTION

Before and after an interruption is performed it is useful to sense the voltage at the interrupter. Some dielectric switchgear systems provide voltage sensing on one side of an interrupter—either the source side or the load side—but not both. Detecting voltages on both the load side and the source side of an interrupter in a switchgear system when the interrupter is in an open position can be beneficial for some applications such as network reconfiguration and distribution automation. Some embodiments of this invention provide a solid dielectric interrupter with two voltage sensing systems imbedded together inside one module for a single phase application.

In one embodiment, the invention provides an interrupter system for a switchgear. The interrupter system includes a source-side conductor, a load side conductor, and an interrupter. A source-side voltage detector is positioned proximate to the source-side conductor and a load-side voltage detector is positioned proximate to the load-side conductor. An insulating overmold encases both conductors, both voltage detectors, and the interrupter. A controller is coupled to both of the detectors and is configured to detect a source-side voltage and a load-side voltage.

In some embodiments, the voltage detectors include cylindrical voltage screens positioned around each conductor in a coaxial arrangement. The controller senses a capacitance between the voltage screen and the corresponding conductor and determines a voltage based on the sensed capacitance.

In some embodiments, the exterior surface of the overmold is covered with a grounded conductive coating such a metallic paint.

Other aspects of the invention will become apparent by consideration of the detailed description and accompanying drawings.

### BRIEF DESCRIPTION OF THE DRAWINGS

FIG. 1 is a perspective view of an interrupter system according to one embodiment.

FIG. 2 is a perspective view of the interrupter system of FIG. 1 encased in an overmold.

FIG. 3 is a perspective view of an interrupter system according to a second embodiment.

### DETAILED DESCRIPTION

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways.

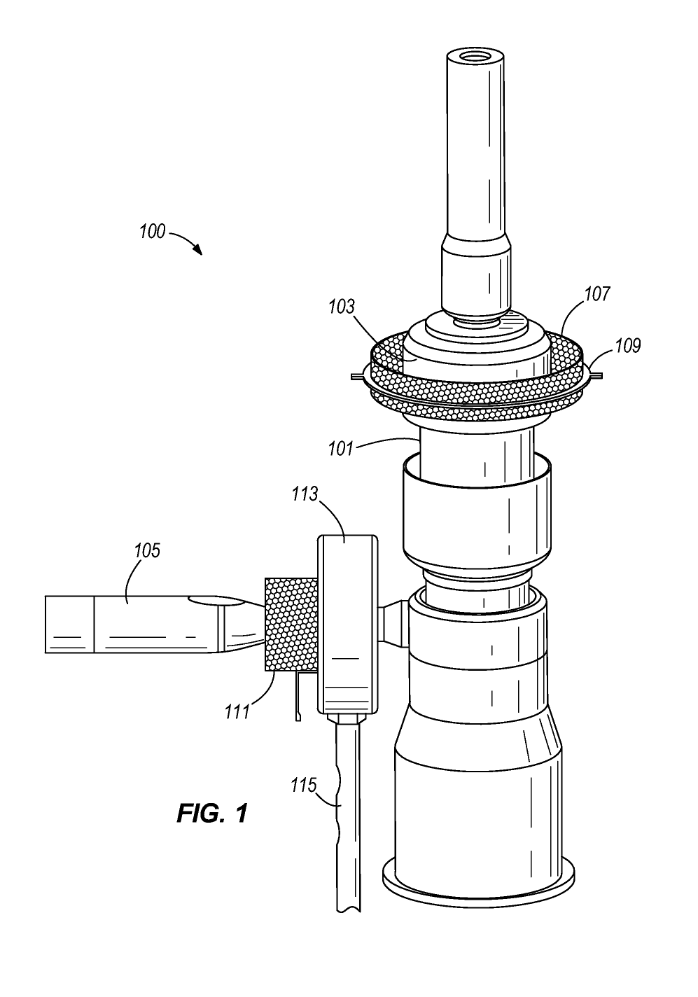

FIG. 1 shows the interrupter system 100 according to one construction. A vacuum interrupter 101 is positioned between a top-side conductor 103 and a bottom-side conductor 105. In this example, the top-side conductor 103 is a source side conductor while the bottom side conductor 105 is a load-side conductor. However, in other embodiments, this orientation may be reversed. A source-side voltage detector is positioned proximate to the top-side conductor. The source-side voltage detector includes a first cylindrical voltage screen 107 positioned around the top-side conductor 103 in a coaxial arrangement at a distance of approximately 17 mm from the surface of the top-side conductor 103. A reinforcement ring 109 assists in positioning the first voltage screen 107 when an overmold is applied to the interrupter system (as described in detail below) and also provides an electrical connection to the first voltage screen 107. Both the first voltage screen 107 and the reinforcement ring 109 are made of a conductive metal such as, for example, aluminum and may be welded together.

During operation, a current is applied through the top-side conductor 103, the interrupter 101, and the bottom-side conductor 105. The first voltage screen 107 and the top-side conductor 103 form a capacitor. The capacitance between the first voltage screen 107 and the top-side conductor 103 depends upon the voltage applied to the top-side conductor 103. Therefore, the voltage of the top-side conductor 103 is determined by sensing the capacitance between the top-side conductor 103 and the first voltage screen 107. The calculation of the voltage of the top-side conductor 103 can be performed by a variety of systems such as a controller located proximate to the interrupter system, a remote computer system, or an ASIC.

Similarly, a load-side voltage detector includes a second cylindrical voltage screen 111 positioned around the bottom-side conductor 105. The capacitance between the second voltage screen 111 and the bottom-side conductor 105 is used to determine a voltage of the bottom-side conductor 105. Because voltage sensing systems are arranged proximate to both the top-side conductor 103 and the bottom-side conductor, the system is able to measure a voltage on either side of the interrupter 101 even when the interrupter 101 is in the open position.

The interrupter system illustrated in FIG. 1 also includes a current transformer 113 placed around the bottom-side conductor 105. Cables and wiring from the current transformer 113 and the second voltage screen 111 are housed in a protection pipe 115.

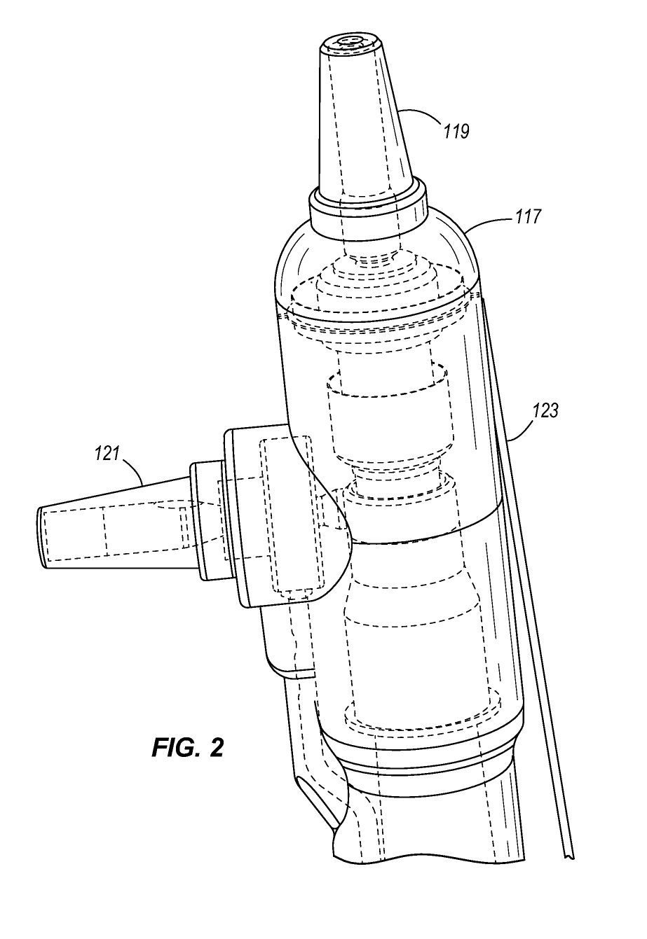

The interrupter system 100 illustrated in FIG. 1 is housed within a single overmold as illustrated in FIG. 2. The encased system also includes a top-side bushing 119 and a bottom-side bushing 121. The bushings 119, 121 are molded as part of the same overmold 117 and are used to connect power cables to the top-side conductor 103 and the bottom-side conductor 105 of the interrupter system 100. In other embodiments, the bushings 119, 121 are formed as separate pieces that are attached to the overmolded interrupter system 100.

As illustrated in FIG. 2, the protective pipe 115 that houses the cables and other wiring from the second voltage screen 111 is encased within the overmold 117. A cable 123 is coupled to the first voltage screen 107 through the reinforcement ring 109 after the overmold 117 is applied.

The overmold 117 consists of an insulating material that is applied by a molding process. The exterior of the overmold 117 is covered with a conductive paint on all surfaces except the top-side bushing 119 and the bottom-side bushing 121. The conductive paint is grounded when the interrupter system 100 is in operation. Grounding the conductive paint on the exterior surface of the overmold 117 provides a fixed grounding reference for the voltage screens 107, 111 and prevents the voltage readings from floating.

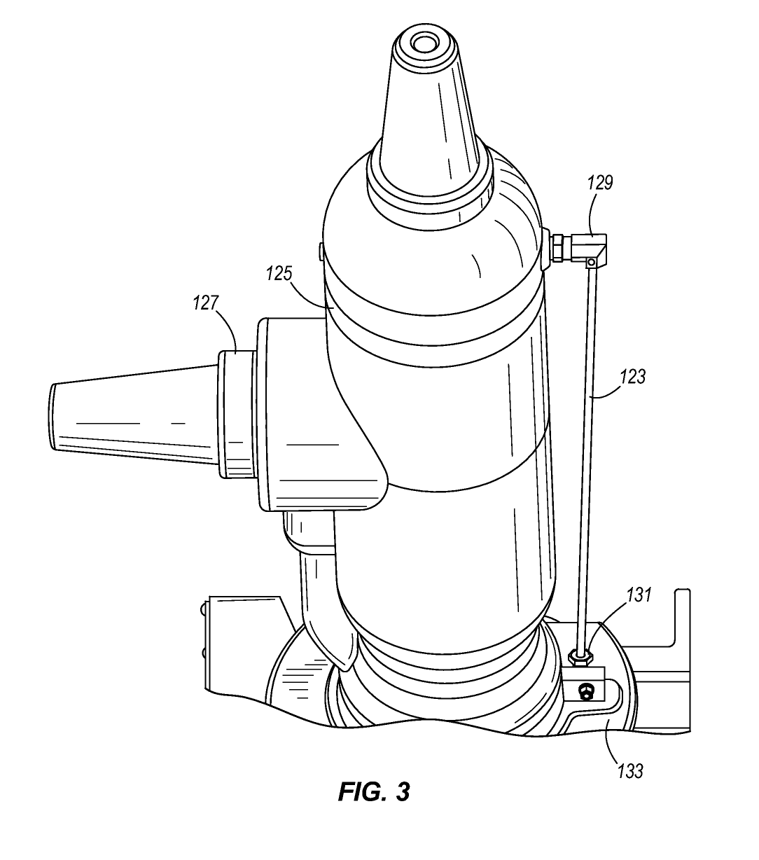

In other constructions, the overmold 117 is covered in another conductive or semiconducitve material that may not cover as much surface area of the overmold 117. For example, in the construction illustrated in FIG. 3, a top-side conductive sleeve 125 is fixed on the outside of the overmold 117 adjacent to the first voltage screen 107. Similarly, a bottom-side conductive sleeve 127 is fixed on the outside of the overmold 117 adjacent to the second voltage screen 111. Each voltage sleeve 125, 127 is electrically coupled to ground to provide a fixed reference voltage for the corresponding voltage screen 107, 111.

FIG. 3 also further illustrates the connections of cable 123 on the exterior of the overmold 117. The cable 123 is connected to the top screen 107 through an upper strain relief connector 129. The upper strain relief connector 129 has a 90-degree downward angle mounted on the exterior of the overmold 117. The cable 123 extends from the upper strain relief connector 129 to a lower strain relief connector 131 mounted on a switch gear housing 133 near the bottom of the interrupter system 100. The upper and lower strain relief connectors 129, 131 maintain tension in the cable 123 while keeping the cable 123 appropriately connected. The upper and lower strain relief connectors 129, 131 also prevent water or moisture from entering the interrupter system 100 and the switchgear housing 133.

Thus, the invention provides, among other things, an interrupter system encased in a single insulating overmold capable of measuring voltages on both the source side and the load side whether the interrupter is opened or closed. Various features and advantages of the invention are set forth in the following claims.

What is claimed is:

1. An interrupter system comprising:
a source-side conductor;
a load-side conductor;
an interrupter coupled to the source-side conductor and the load-side conductor;
a source-side voltage detector positioned proximate to the source-side conductor;
a load-side voltage detector positioned proximate to the load-side conductor;
an insulating overmold encasing the source-side conductor, the load-side conductor, the interrupter, the source-side voltage detector, and the load-side voltage detector; and
a controller coupled to the source-side voltage detector and the load-side voltage detector configured to determine a source-side voltage and a load-side voltage.

2. The interrupter system of claim 1, wherein the source-side voltage detector includes a cylindrical voltage screen positioned around the source-side conductor in a coaxial arrangement, and wherein the controller is configured to determine a capacitance between the cylindrical voltage screen and the source-side conductor and to determine the source-side voltage based on the determined capacitance.

3. The interrupter system of claim 2, wherein an exterior of the insulating overmold is covered with a conductive coating, and wherein the conductive coating is grounded.

4. The interrupter system of claim 3, wherein the conductive coating includes a conductive paint.

5. The interrupter system of claim 2, further comprising a sleeve positioned outside of the insulating overmold around the source-side conductor and the cylindrical voltage screen in a coaxial arrangement.

6. The interrupter system of claim 2, wherein the load-side voltage detector includes a second cylindrical voltage screen positioned around the load-side conductor in a coaxial arrangement, and wherein the controller is configured to determine a second capacitance between the second cylindrical voltage screen and the load-side conductor and to calculate the load-side voltage based on the determined second capacitance.

7. The interrupter system of claim 2, further comprising a conductive reinforcement ring positioned around the cylindrical voltage screen and in electrical contact with the cylindrical voltage screen.

8. The interrupter system of claim 1, wherein the interrupter includes a dielectric vacuum interrupter.

9. The interrupter system of claim 1, further comprising a source-side bushing connected to the source-side conductor and a load-side bushing connected to the load-side conductor, wherein the source-side bushing and the load-side bushing are not encased within the insulating overmold.

10. The interrupter system of claim 1, further comprising
a cable electrically coupled to the controller and one of the source-side voltage detector and the load-side voltage detector; and
a protection pipe encased within the insulating overmold, wherein the cable is positioned within the protection pipe.

11. The interrupter system of claim 10, further comprising a second cable electrically coupled to the controller and the other of the source-side voltage detector and the load-side voltage detector, wherein a majority of the second cable is not encased within the insulating overmold.

12. An interrupter system for a switchgear comprising:
a vacuum interrupter;
a source-side conductor connected to the vacuum interrupter;
a load-side conductor connected to the vacuum interrupter;
a source-side cylindrical voltage sensing screen positioned around the source-side conductor in a coaxial arrangement;
a load-side cylindrical voltage sensing screen positioned around the load-side conductor in a coaxial arrangement;
an insulating overmold encasing the source-side conductor, the load-side conductor, the source-side cylindrical voltage sensing screen, the load-side cylindrical voltage sensing screen, and the interrupter;
a first reference ground element positioned on a first exterior surface of the insulating overmold around the source-side cylindrical voltage sensing screen;
a second reference ground element positioned on a second exterior surface of the insulating overmold around the load-side cylindrical voltage sensing screen; and
a controller not encased by the insulating overmold electrically coupled to the source-side cylindrical voltage sensing screen and the load-side cylindrical voltage sensing screen and configured to
determine a first capacitance between the source-side cylindrical voltage sensing screen and the source-side conductor,
determine a source-side voltage based on the first capacitance,
determine a second capacitance between the load-side cylindrical voltage sensing screen and the load-side conductor, and
determine a load-side voltage based on the second capacitance.

13. The interrupter system of claim 12, further comprising a conductive coating on an entire exterior surface of the insulating overmold electrically coupled to a reference ground, wherein the conductive coating includes the first reference ground element and the second reference ground element.

14. The interrupter system of claim 12, further comprising a protection pipe encased within the insulating overmold,
wherein a first cable connected to the controller and one of the source-side cylindrical voltage sensing screen and the load-side cylindrical voltage sensing screen is positioned within the protection pipe, and
wherein a second cable connected to the controller and the other of the source-side cylindrical voltage sensing screen and the load-side cylindrical voltage sensing screen is positioned external to the insulating overmold.

15. The interrupter system of claim 14, wherein a first end of the second cable is connected to the other of the source-side cylindrical voltage sensing screen and the load-side cylindrical voltage sensing screen through a water-tight strain relief connector mounted on the exterior of the insulating overmold.
